(19) United States
(12) Patent Application Publication
(10) Pub. No.: US 2025/0017269 A1
(43) Pub. Date: Jan. 16, 2025

(54) ATOMIZERS AND AEROSOL GENERATING DEVICES

(71) Applicant: SHENZHEN WOODY VAPES TECHNOLOGY CO., LTD., Shenzhen (CN)

(72) Inventors: Ying CHENG, Shenzhen (CN); Chengxin JIA, Shenzhen (CN)

(73) Assignee: SHENZHEN WOODY VAPES TECHNOLOGY CO., LTD., Shenzhen (CN)

(21) Appl. No.: 18/398,947

(22) Filed: Dec. 28, 2023

(30) Foreign Application Priority Data
Jul. 10, 2023 (CN) 202321798060.3
Oct. 13, 2023 (CN) 202322766064.X

(51) Int. Cl. A24F 40/44; A24F 40/10; A24F 40/42; A24F 40/46; A24F 40/485; H05B 1/02

(52) U.S. Cl. CPC A24F 40/44; A24F 40/10; A24F 40/42; A24F 40/46; A24F 40/485; H05B 1/0244

(57) ABSTRACT

Disclosed are an atomizer and an aerosol generating device. The atomizer includes: an atomizer tube, one or more liquid inlet holes being disposed on a side wall of the atomizer tube; a liquid reservoir disposed on an outer side of the atomizer tube and fluidly interconnected with the atomizer tube through the liquid inlet holes; a liquid-conducting member fitted to an inner side wall of the atomizer tube and connected to the liquid inlet holes; an atomizing assembly disposed in the atomizer tube and in contact with the liquid-conducting member, wherein the atomizing assembly is positioned higher than the liquid inlet holes in an axial direction of the atomizer tube.

### CROSS-REFERENCE TO RELATED APPLICATIONS

This application claims priority to Chinese Patent Application No. 202321798060.3, filed on Jul. 10, 2023, and Chinese Patent Application No. 202322766064.X, filed on Oct. 13, 2023, the contents of which are incorporated herein by reference in their entireties.

### TECHNICAL FIELD

The present disclosure relates to the field of devices for generating an aerosol, and more particularly, to an atomizer and an aerosol generating device.

### BACKGROUND

With the increase in demand for aerosol generating devices, there is a need to improve the structure of the atomizer in the aerosol generating device. For the atomizer of the conventional aerosol generating device, liquid inlet holes are generally disposed on the middle region of the cotton-coated component of the atomizing assembly. The aerosolizable matrix is transferred to the heating element of the atomizing assembly through the liquid inlet holes under the action of gravity of the aerosolizable matrix in combination with the liquid-conducting characteristics of the liquid-conducting member. In this arrangement, a large amount of aerosolizable matrix may be absorbed to the liquid-conducting member due to gravity thereof when the aerosol generating device stands for a long time, resulting in excess aerosolizable matrix on the liquid-conducting member, even penetrating into the air inlet passage of the atomizer. As a result, the leakage of aerosolizable matrix occurs in the aerosol generator device, affecting the normal use thereof.

### SUMMARY

One or more embodiments of the present disclosure provide an atomizer, which includes an atomizer tube, one or more liquid inlet holes being disposed on a side wall of the atomizer tube; a liquid reservoir disposed on an outer side of the atomizer tube and fluidly interconnected with the atomizer tube through the liquid inlet holes; a liquid-conducting member fitted to an inner side wall of the atomizer tube and connected to the liquid inlet holes; an atomizing assembly disposed in the atomizer tube and in contact with the liquid-conducting member. The atomizing assembly is positioned higher than the liquid inlet holes in an axial direction of the atomizer tube.

One or more embodiments of the present disclosure provides an aerosol generating device including a housing and an atomizer mounted in the housing. The atomizer includes: an atomizer tube, one or more liquid inlet holes being disposed on a side wall of the atomizer tube; a liquid reservoir disposed on an outer side of the atomizer tube and fluidly interconnected with the atomizer tube through the liquid inlet holes; a liquid-conducting member fitted to an inner side wall of the atomizer tube and connected to the liquid inlet holes; an atomizing assembly disposed in the atomizer tube and in contact with the liquid-conducting member. The atomizing assembly is positioned higher than the liquid inlet holes in an axial direction of the atomizer tube.

### BRIEF DESCRIPTION OF DRAWINGS

In order to illustrate the embodiments of the present disclosure, the accompanying drawings to be used in the description of the embodiments will be briefly introduced below. It is apparent that the accompanying drawings in the following description are some of the embodiments of the present disclosure, and other accompanying drawings can be obtained by a person of ordinary skill in the art according to these drawings without creative effort.

FIG. 1 is a schematic cross-sectional view of an atomizer according to some embodiments of the present disclosure.

FIG. 2 is a schematic exploded view of an atomizer according to some embodiments of the present disclosure.

FIG. 3 is a schematic diagram of a structure of a liquid-conducting member according to some embodiments of the present disclosure.

FIG. 4 is a schematic diagram of a structure of a liquid-conducting member according to some embodiments of the present disclosure.

FIG. 5 is a schematic perspective view of an atomizer according to some embodiments of the present disclosure.

FIG. 6 is a schematic perspective view of a base according to some embodiments of the present disclosure.

FIG. 7 is an isometric view of an atomizer according to some embodiments of the present disclosure.

FIG. 8 is a schematic perspective view of an atomizer tube according to some embodiments of the present disclosure.

FIG. 9 is a schematic perspective view of a liquid reservoir according to some embodiments of the present disclosure.

FIG. 10 is a schematic cross-sectional view of an aerosol generating device according to some embodiments of the present disclosure.

FIG. 11 is a schematic front view of an aerosol generating device according to some embodiments of the present disclosure.

### LIST OF REFERENCE NUMBERS

10. Atomizer tube; 101. Liquid inlet hole; 20. Liquid-conducting member; 21. First liquid-conducting member; 22. Second liquid-conducting member; 30. Atomizing assembly; 301. Liquid-absorbing member; 302. Heating element; 303. Cotton-coated metal member; 40. Base; 401. Positioning sleeve; 402. Annular sealing groove; 60. Liquid reservoir; 200. Aerosol generating device; 210. Housing; 100. Atomizer.

### DETAILED DESCRIPTION

Embodiments of the present disclosure will now be described in detail below with reference to the accompanying drawings. It is apparent that the described embodiments are some of the embodiments of the present disclosure, rather than all of the embodiments. All other embodiments, which are made by a person of ordinary skill in the art without involving any inventive effort, based on the embodiments of the present disclosure, are within the scope of the present disclosure.

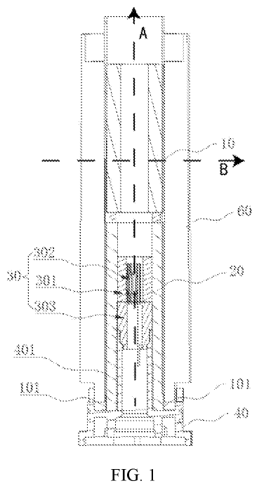

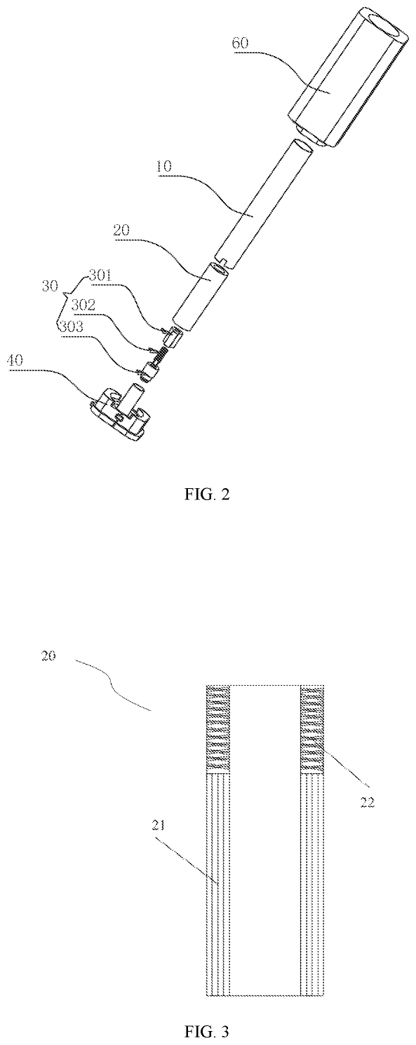

Referring to FIG. 1, it shows a schematic cross-sectional view of an atomizer according to some embodiments of the present disclosure. Referring to FIG. 2, it shows a schematic exploded view of an atomizer according to some embodiments of the present disclosure. The atomizer includes an atomizer tube 10, a liquid reservoir 60, a liquid-conducting member 20, and an atomizing assembly 30. Liquid inlet holes 101 are disposed on a side wall of the atomizer tube 10. The liquid reservoir 60 is disposed on the outer side of the atomizer tube 10, and may be fluidly interconnected to the atomizer tube 10 through the liquid inlet holes 101. The liquid-conducting member 20 are fitted to the inner side wall of the atomizer tube 10 and connected to the liquid inlet holes 101. The atomizing assembly 30 is disposed in the atomizer tube 10 and is in contact with the liquid-conducting member 20. In an axial direction of the atomizer tube 10, the atomizing assembly 30 is positioned higher than the liquid inlet holes 101.

In some embodiments, the atomizer tube 10 is of a tubular shape. The internal space of the atomizer tube 10 is configured to carry out atomization reactions, and is in communication with the exterior of the atomizer through a gas inlet hole or a gas inlet passage. The atomizing assembly 30 is accommodated in the interior of the atomizer tube 10. The atomizer tube 10 may be made of a metal capable of withstanding high temperature during the atomization reaction, such as stainless steel, aluminum, and iron.

The liquid inlet holes 101 that are disposed on the side wall of the atomizer tube 10 are through holes or openings. The liquid inlet holes 101 are provided such that the atomizer tube 10 is in communication with the liquid reservoir 60. The liquid inlet holes 101 are disposed at a position close to the lower of the atomizer tube 10. The liquid inlet holes 101 may be formed as a notch at the lower of the atomizer tube 10. An aerosolizable matrix in the liquid reservoir 60 may enter into the atomizer tube 10 through the liquid inlet holes 101. In this case, the matrix-entering amount per unit is related to a diameter of the liquid inlet holes 101. The diameter of the liquid inlet holes 101 may be determined according to actual requirements.

The liquid-conducting member 20 is disposed in the atomizer tube 10. Two ends of the liquid-conducting member 20 extend toward the top end and the bottom end of the atomizer tube 10, respectively. The lower end of the liquid-conducting member 20 is connected to the liquid inlet holes 101. The liquid-conducting member 20 has characteristics of absorbing and storing liquids, and may be made of cotton, a porous solid, ceramic, and other materials. In some embodiments, the liquid-conducting member 20 is made of polyester fiber cotton. The atomizing assembly 30 is connected to an upper portion of the liquid-conducting member 20 extending toward the top end of the atomizer tube 10, and is in close contact with the liquid-conducting member 20.

The liquid-conducting member 20 may be used as a medium for connecting the liquid inlet holes 101 and the atomizing assembly 30. After the aerosolizable matrix in the liquid reservoir 60 enters into the atomizer tube 10 through the liquid inlet holes 101, the aerosolizable matrix may be absorbed onto the liquid-conducting member 20, and then transferred to the atomizing assembly 30 under a capillary effect of the liquid-conducting member 20. At this time, the liquid-conducting member 20 may be permeated with the aerosolizable matrix, and the permeated liquid-conducting member 20 can function as a sealing plug. In this case, the air pressure in the liquid reservoir 60 is less than or equal to the external atmospheric pressure. Therefore, the action of gravity of the aerosolizable matrix in the liquid reservoir 60 fails due to the negative space pressure, and the liquid reservoir 60 stops supplying the aerosolizable matrix to the liquid-conducting member 20. This may prevent excess aerosolizable matrix from being absorbed on the liquid-conducting member 20. As the suction is performed, a certain amount of the aerosolizable matrix may be consumed in the atomizing assembly 30, so that the aerosolizable matrix absorbed on the liquid-conducting member 20 is reduced, and the negative space pressure is changed. Then, the liquid reservoir 60 continues to supply the aerosolizable matrix to the liquid-conducting member 20 through the liquid inlet holes 101. The liquid-conducting member 20 may quantitatively supply the aerosolizable matrix to the atomizing assembly 30 depended on the consumption amount of the aerosolizable matrix in the atomizing assembly 30. The amount of the aerosolizable matrix transferred to the atomizing assembly 30 matches the amount required for the atomization reaction, preventing excess aerosolizable matrix on the atomizing assembly 30. This arrangement may avoid leakage of the aerosolizable matrix due to excess aerosolizable matrix entering into the air inlet passage for the atomization reaction, and avoid purring due to excess aerosolizable matrix on the atomizing assembly 30 during suction.

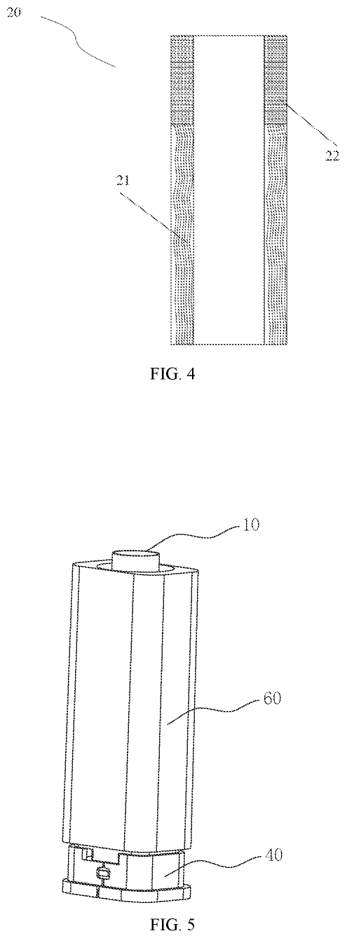

In some embodiments, referring to FIGS. 3 and 4, the two show a schematic diagram of a structure of a liquid-conducting member 20 according to some embodiments of the present disclosure, respectively. The liquid-conducting member 20 includes a first liquid-conducting member 21 and a second liquid-conducting member 22 sequentially arranged from bottom to top along the axial direction A of the atomizer tube 10. The atomizing assembly 30 is disposed within the second liquid-conducting member 22. The first liquid-conducting member 21 contains first fibers that extend along the axial direction of the atomizer tube 10, and the second liquid-conducting member 22 contains second fibers that extend along a radial direction B of the atomizer tube 10, in which the axial direction of the atomizer tube 10 is perpendicular to the radial direction thereof. Since the first liquid-conducting member 21 and the second liquid-conducting member 22 are sequentially arranged in the atomizer tube 10 from bottom to top, the aerosolizable matrix is first absorbed by the first liquid-conducting member 21, and then may be rapidly transferred upward due to the first fibers of the first liquid-conducting member 21 extending along the axial direction. As a result, the aerosolizable matrix is absorbed by the second liquid-conducting member 22. Since the second fibers of the second liquid-conducting member 22 extend along the radial direction, the aerosolizable matrix may be rapidly transferred to the atomizing assembly 30, in which the aerosolizable matrix may be heated and atomized to form a foggy aerosol. Then, the aerosol may be delivered from the atomizer tube 10 for use by a user.

The first fibers of the first liquid-conducting member 21 extending along the axial direction of the atomizer tube 10 means that an angle between each part of the first fibers and the axial direction is less than 30 degrees. The second fibers of the second liquid-conducting member 22 extending along the radial direction of the atomizer tube 10 means that an angle between each part of the second fibers and the radial direction is less than 30 degrees. By setting the first fibers of the first liquid-conducting member 21 extending along the axial direction and the second fibers of the second liquid-conducting member 22 extending along the radial direction, it is possible to achieve rapidly adsorption and transfer of the aerosolizable matrix, thereby avoiding low flow guide rate and leakage.

In some embodiments, the length of the first liquid-conducting member 21 in the axial direction is greater than the length of the second liquid-conducting member 22 in the axial direction. The first fibers of the first liquid-conducting member 21 extend along the axial direction, so that the first liquid-conducting member 21 is capable of rapidly absorbing and transferring the aerosolizable matrix upward to the second liquid-conducting member 22. The second liquid-conducting member 22 functions to absorb and transfer the aerosolizable matrix to the atomizing assembly 30, and therefore the second liquid-conducting member 22 may be designed to only wrap the atomizing assembly 30. The length of the first liquid-conducting member 21 in the axial direction is larger than that of the second liquid-conducting member 22 in the axial direction, so that the height of the second liquid-conducting member 22 may be increased, thereby achieving the increase of the height of the atomizing assembly 30, shortening the flow path of the aerosol, and further ensuring the taste of the aerosol.

In some embodiments, the length of the first liquid-conducting member 21 in the axial direction is 25 mm to 30 mm, so as to satisfy the increase of the height of the atomizing assembly 30. The length of the second liquid-conducting member 22 in the axial direction is 10 mm to 15 mm, so as to fully wrap the atomizing assembly 30.

In some embodiments, the first fibers of the first liquid-conducting member 21 are arranged in a linear pattern, a curved pattern, or a combination thereof, and it only needs to satisfy the first fibers of the first liquid-conducting member 21 extending along the axial direction.

In some embodiments, the second fibers of the second liquid-conducting member 22 are arranged in a linear pattern, a curved pattern, or a combination thereof, and it only needs to satisfy the second fibers of the second liquid-conducting member 22 extending along the radial direction.

In some embodiments, referring to FIG. 3, the first fibers of the first liquid-conducting member 21 are arranged in a linear pattern along the axial direction. The first liquid-conducting member 21 has a porosity of 92% or more, so as to achieve rapidly absorbing and upwardly transferring the aerosolizable matrix. The second fibers of the second liquid-conducting member 22 are arranged in another liner pattern in which the second fibers cross in the radial intersection. The second liquid-conducting member 22 has a porosity of 92% or more, so as to achieve absorbing and rapidly transferring the aerosolizable matrix to the atomizing assembly 30.

In some embodiments, referring to FIG. 4, the first fibers of the first liquid-conducting member 21 are arranged in a curved pattern along the axial direction, which can also meet the purpose of rapidly absorbing and upwardly transferring the aerosolizable matrix. The second fibers of the second liquid-conducting member 22 are arranged in a liner pattern in which the second fibers are provided in a breakpoint form along the radial direction, which can also meet the purpose of absorbing and rapidly transferring the aerosolizable matrix to the atomizing assembly 30.

In some embodiments, the first liquid-conducting member 21 and the second liquid-conducting member 22 are of a cylindrical shape and abut against the inner wall of the atomizer tube 10, so that the first liquid-conducting member 21 and the second liquid-conducting member 22 can be fitted and fixed to the atomizer tube 10, thereby ensuring the stability of the first liquid-conducting member 21 and the second liquid-conducting member 22, and leaving sufficient space for gas to flow between the first liquid-conducting member 21 and the second liquid-conducting member 22.

In some embodiments, radial thicknesses of the first liquid-conducting member 21 and the second liquid-conducting member 22 are 5 mm to 10 mm, and the first liquid-conducting member 21 and the second liquid-conducting member 22 may absorb an enough amount of the aerosolizable matrix, prevent the atomizing assembly 30 from heating in a case of insufficient fluid due to the slow flow guide rate, and keep sufficient space between the first liquid-conducting member 21 and the second liquid-conducting member 22 to allow gas to flow between the first liquid-conducting member 21 and the second liquid-conducting member 22.

The atomizing assembly 30, as a core component of the atomizer, is configured to atomize the aerosolizable matrix to generate an aerosol. The atomizing assembly 30 is positioned at a distance above the liquid inlet holes 101 along the axial direction of the atomizer tube 10, and the distance may be designed according to the actual requirements, which is not limited herein. Since the atomizing assembly 30 is positioned at a distance above the liquid inlet holes 101 along the axial direction of the atomizer tube 10, and the liquid-conducting member 20 is used to connect the liquid inlet holes 101 and the atomizing assembly 30 to transfer the aerosolizable matrix, a negative pressure can be generated between the liquid reservoir 60 and the atomizing assembly 30. Under the action of the negative space pressure of the liquid reservoir 60, the aerosolizable matrix may be quantitatively guided to the atomizing assembly 30 via the liquid-conducting member 20 for the atomization reaction, thereby effectively avoiding the leakage of the atomizer caused by the adsorption of excess aerosolizable matrix on the liquid-conducting member 20. Thus, the practicality of the atomizer is enhanced.

In some embodiments, referring to FIGS. 1 and 2 again, the atomizing assembly 30 includes a liquid-absorbing member 301 and a heating element 302. The outer side of the liquid-absorbing member 301 is fitted to an inner side wall of the second liquid-conducting member 22 facing away from the atomizer tube 10, and the bottom end of the liquid-absorbing member 301 is positioned higher than the liquid inlet holes 101. The heating element 302 is wrapped by the liquid-absorbing member 301. The aerosolizable matrix absorbed in the second liquid-conducting member 22 is transferred to the liquid-absorbing member 301 and heated by the heating element 302, so as to be atomized into a foggy aerosol, and then the aerosol may be discharged out through the atomizer tube 10. The existence of the liquid-absorbing member 301 may prevent the heating element 302 from directly heating the second liquid-conducting member 22 with no or little liquid.

The heating element 302 may generate heat. The heating element 302 may be a heating wire. The heating element 302 may control the heating to atomize the aerosolizable matrix, resulting in forming an aerosol. The liquid-absorbing member 301 is of a cylindrical shape, and the outer side wall of the liquid-absorbing member 301 is fitted to the side of the liquid-conducting member 20 facing away from the atomizer tube 10. The liquid-absorbing member 301 is in close contact with the liquid-conducting member 20, and the bottom end of the liquid-absorbing member 301 is positioned at a distance above the liquid inlet holes 101. The heating element 302 is completely wrapped by the liquid-absorbing member 301, and is in close contact with the liquid-absorbing member 301. The liquid-absorbing member 301 can withstand the high temperature generated by the heating element 302. In addition, the liquid-absorbing member 301 has the characteristics of absorbing and storing liquids. The liquid may penetrate from the outer side of the liquid-absorbing member 301 to the inner side thereof, allowing the liquid-absorbing member 301 to be permeated. The liquid-absorbing member 301 may be made of a material such as cotton, a porous solid, polyester fibers, and glass fibers. The aerosolizable matrix is first absorbed to the liquid-conducting member 20 at a portion of the liquid-conducting member 20 that is flush with the liquid inlet 101. After running a certain distance on the liquid-conducting member 20, the aerosolizable matrix is absorbed to the liquid-absorbing member 301, until the liquid-absorbing member 301 is completely permeated. Then, the aerosolizable matrix is in contact with the heating element 302, and the atomization reaction is performed. As the aerosolizable matrix on the liquid-absorbing member 301 consumed by the heating element 302, the negative space pressure is changed, and another portion of the aerosolizable matrix may enter into the liquid-conducting member 20 from the liquid inlet holes 101 and continues to permeate the liquid-conducting member 20. As a result, quantitative liquid supply may be achieved under the action of negative space pressure, thereby effectively avoiding the liquid leakage caused by excess aerosolizable matrix on the liquid-conducting member 20.

In some embodiments, the bottom end of the liquid-absorbing member 301 is spaced 0 mm to 28 mm from the top edge of the liquid inlet holes 101 along the axial direction of the atomizer tube 10. Since the position of the liquid-absorbing member 301 is higher than the position of the liquid inlet holes 101 of the atomizer tube 10, if the distance between the liquid-absorbing member 301 and the liquid inlet holes 101 is too large, the path through which the aerosolizable matrix runs and transfers on the liquid-conducting member 20 is too long, resulting in undesired liquid supply amount and poor atomizing effect. The bottom end of the liquid-absorbing member 301 is set to be spaced 0 mm to 28 mm from the top edge of the liquid inlet holes 101 along the axial direction of the atomizer tube 10, so that the liquid-conducting efficiency of the liquid-conducting member 20 can be optimized, and the liquid amount on the liquid-absorbing member 301 meet the requirements for normal atomizing consumption. Therefore, the aerosolizable matrix may be not excessively absorbed to the liquid-conducting member 20 due to the influence of gravity, avoiding the liquid leakage, and an insufficient supply of the aerosolizable matrix due to an excessively long supply path may be avoided.

In some embodiments, the distance between the bottom end of the liquid-absorbing member 301 and the top edge of the liquid inlet holes 101 along the axial direction of the atomizer tube 10 is 5 mm to 20 mm. In order to meet the liquid supply requirements in different scenarios, the distance between the bottom end of the liquid-absorbing member 301 and the top edge of the liquid inlet holes 101 can be designed to be in the range of 5 mm to 20 mm. For example, the distance between the bottom end of the liquid-absorbing member 301 and the top edge of the liquid inlet holes 101 is designed to be 5 mm. In this case, the distance between the liquid-absorbing member 301 and the liquid inlet holes 101 is relatively close, and the liquid transferring path is short, so that the liquid supply requirements for atomization of the high-power atomizing assembly 30 can be met. When the distance between the liquid-absorbing member 301 and the liquid inlet holes 101 is 10 mm, the distance between the liquid-absorbing member 301 and the liquid inlet holes 101 is moderate, and the liquid supply path is moderate, so that the liquid supply requirements for atomization of the moderate power atomizing assembly 30 can be met. When the distance between the liquid-absorbing member 301 and the liquid inlet holes 101 is 20 mm, the distance is relatively far away, and the liquid supply path is relatively long, so that the liquid supply requirements for atomization of the low-power atomizing assembly 30 can be met. The distance can be designed based on different atomizing assemblys.

In some embodiments, referring to FIGS. 1 and 5, the atomizer includes a base 40. The liquid reservoir 60 is disposed on the base 40, and the bottom end of the liquid reservoir 60 is sealed by the base 40. The atomizer tube 10 is accommodated in the liquid reservoir 60. The base 40 is a mounting base for components of the atomizer. The liquid reservoir 60 has a hollow cavity, and the bottom end of the liquid reservoir 60 is sealed by the base 40. A good fluid tightness may be maintained at an abutment between the liquid reservoir 60 and the base 40. In order to improve the tightness, the base 40 may be made of an elastic material such as silicone. The atomizer tube 10 is accommodated in the hollow cavity of the liquid reservoir 60, and the top end of the atomizer tube 10 extends through the top of the liquid reservoir 60. A good fluid tightness is maintained at an abutment between the side wall of the upper of the atomizer tube 10 and the top of the liquid reservoir 60. The outer side wall of the atomizer tube 10 and the inner wall of the liquid reservoir 60 together form a space that holds the aerosolizable matrix. The atomizer tube 10 separates the aerosolizable matrix in the space from the atomizing assembly 30, and the aerosolizable matrix is filled outside the atomizer tube 10. The supply of the aerosolizable matrix through the liquid inlet holes 101 is convenient.

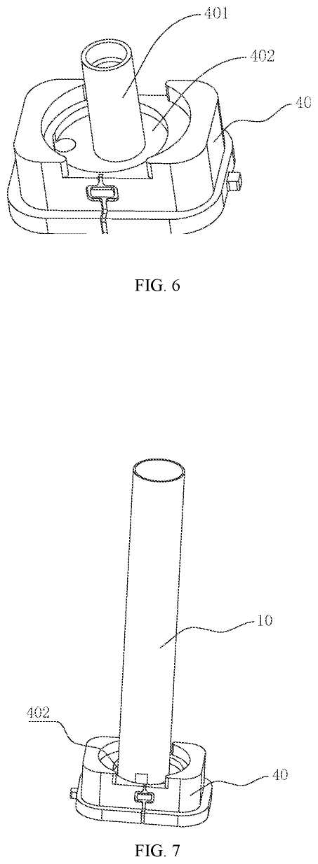

Further, referring to FIGS. 6 and 7, a positioning sleeve 401 is disposed on the base 40. The atomizer tube 10 is sleeved on the positioning sleeve 401. The liquid-conducting member 20 is disposed between the atomizer tube 10 and the positioning sleeve 401. The positioning sleeve 401 is a hollow cylindrical convex structure, which is communicated with the base 40. The outer diameter of the positioning sleeve 401 is less than the inner diameter of the atomizer tube 10, and the length of the positioning sleeve 401 is less than the length of the atomizer tube 10. The liquid-conducting member 20 is of a cylindrical shape, and the inner diameter of the liquid-conducting member 20 is larger than the outer diameter of the positioning sleeve 401, and the outer diameter of the liquid-conducting member 20 is less than the inner diameter of the atomizer tube 10. The liquid-conducting member 20 and the atomizer tube 10 are sleeved on the positioning sleeve 401, and the liquid-conducting member 20 is located between the atomizer tube 10 and the positioning sleeve 401, thereby preventing the atomizer tube 10 and the liquid-conducting member 20 from moving under the action of force. In addition, the positioning sleeve 401 may serve as the air inlet passage for the atomization reaction. The positioning sleeve 401 communicates the atomization site in the atomizing assembly 30 with the external atmosphere. The external air enters the atomizing assembly 30 through the positioning sleeve 401 to carry out the atomization reaction and generate the aerosol

Referring to FIGS. 1 and 2 again, the atomizing assembly 30 includes a cotton-coated metal member 303. The bottom end of the cotton-coated metal member 303 is embedded in the positioning sleeve 401, and the bottom end of liquid-absorbing member 301 abuts the top of the cotton-coated metal member 303. That is, the cotton-coated metal member 303 may serve as an atomizing base of the atomizing assembly 30. The cotton-coated metal member 303 is made of a high-temperature-resistant metal material. The bottom end of the cotton-coated metal member 303 is embedded in the top of the positioning sleeve 401 by a certain length. The top end of the cotton-coated metal member 303 abuts against the bottom end of the liquid-absorbing member 301 to provide support and positioning for the liquid-absorbing member 301, so that the liquid-absorbing member 301 and the heating element 302 may maintain stability.

In some embodiments, referring to FIGS. 7 and 9, an annular sealing groove 402 is formed on the base 40 and surrounds the outside of the positioning sleeve 401. The bottom of the liquid reservoir 60 is embedded in the annular sealing groove 402. The annular sealing groove 402 is an annular recess formed in the periphery of the positioning sleeve 401. The annular scaling groove 402 surrounds the outer side of positioning sleeve 401. The side wall of the lower end of the liquid reservoir 60 is fitted to the side wall of the annular sealing groove 402. The lower portion of the liquid reservoir 60 is embedded in the annular scaling groove 402 by a certain length. The portion of the liquid reservoir 60 embedded in the annular sealing groove 402 is kept in close contact with the annular scaling groove 402, leading to a superior fluid tightness therebetween, and avoiding the leakage of the aerosolizable matrix to the outside of the liquid reservoir 60.

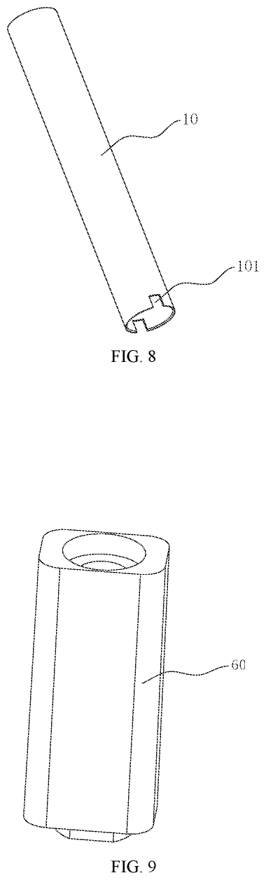

In some embodiments, referring to FIG. 8, the liquid inlet holes 101 are disposed on the lower side wall of the atomizer tube 10. In some embodiments, one or more liquid inlet holes 101 may be disposed on the atomizer tube 10. Herein, the liquid inlet holes 101 are designed as a notch on the lower side wall of the atomizer tube 10, and the number thereof is not limited. The diameter and the number of the liquid inlet holes 101 may be designed according to the liquid supply amount for the atomizing assembly 30 as needed. When the diameter is larger, the number of the liquid inlet holes 101 may be set less. When the diameter is smaller, the number of the liquid inlet holes 101 can be set more. The liquid inlet holes 101 are spaced at the same distance apart from each other on the circumference of the atomizer tube 10, which may allow the liquid supply amount to be uniform. In some embodiments, two liquid inlet holes 101 are provided, and the two liquid inlet holes are distributed on opposite sides of the lower side wall of the atomizer tube 10.

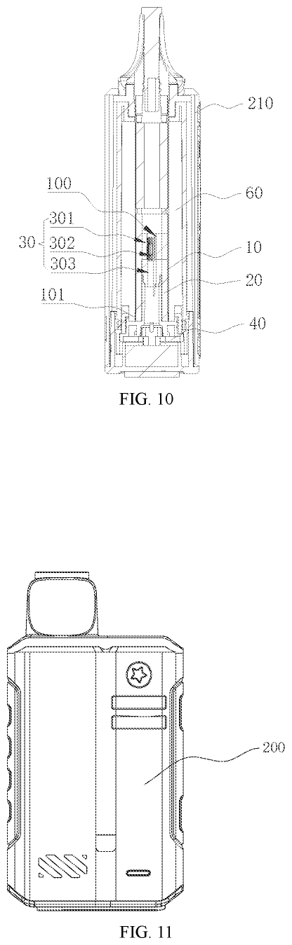

In some embodiments, referring to FIGS. 10 and 11, there is provided an aerosol generating device 200. The aerosol generating device 200 includes a housing 210 and an atomizer 100. The aerosol generating device 200 may also include components, such as a battery, a control board, and a power control module. The atomizer 100 is mounted in the housing 210. The atomizer 100 functions to provide an atomization function. The aerosol generating device 200 may generate an aerosol by cooperating the atomizer 100 with various internal components. The atomizer 100 according to the embodiment of the present disclosure may employ any one of the atomizers provided by the present disclosure. Since the detailed structure and the working principle of the atomizer have been described in detail in the foregoing description, for the sake of simplicity of the description, details are not described herein.

According to the embodiments of the present disclosure, the atomizer is applied in the aerosol generating device, and thus no leakage of the aerosolizable matrix occurs during use or even leaving unused for a long time, leading to more practicality.

The foregoing is a description of some embodiments of the present disclosure, but the scope of the present disclosure is not limited thereto. A person skilled in the art can readily consider various equivalent modifications or substitutions within the scope of the present disclosure. The modifications or substitutions shall be encompassed within the scope of the present disclosure. Therefore, the scope of the present disclosure shall be defined by the accompanying claims.

What is claimed is:

1. An atomizer comprising:
an atomizer tube, one or more liquid inlet holes being disposed on a side wall of the atomizer tube;
a liquid reservoir disposed on an outer side of the atomizer tube and fluidly interconnected with the atomizer tube through the liquid inlet holes;
a liquid-conducting member fitted to an inner side wall of the atomizer tube and connected to the liquid inlet holes;
an atomizing assembly disposed in the atomizer tube and in contact with the liquid-conducting member, wherein the atomizing assembly is positioned higher than the liquid inlet holes in an axial direction of the atomizer tube.

2. The atomizer according to claim 1, wherein the liquid-conducting member comprises a first liquid-conducting member and a second liquid-conducting member arranged sequentially from bottom to top along the axial direction of the atomizer tube, and the atomizing assembly is disposed in the second liquid-conducting member.

3. The atomizer according to claim 2, wherein a length of the first liquid-conducting member is greater than a length of the second liquid-conducting member in the axial direction.

4. The atomizer according to claim 2, wherein a thickness of each of the first liquid-conducting member and the second liquid-conducting member in a radial direction of the atomizer tube is 5 mm to 10 mm.

5. The atomizer according to claim 2, wherein outer side walls of the first liquid-conducting member and the second liquid-conducting member are fitted to the inner side wall of the atomizer tube.

6. The atomizer according to claim 2, wherein the first liquid-conducting member contains first fibers that extend in the axial direction of the atomizer tube, and the second liquid-conducting member contains second fibers that extend in a radial direction of the atomizer tube.

7. The atomizer according to claim 6, wherein a porosity of the first liquid-conducting member is 92% or more, and a porosity of the second liquid-conducting member is 92% or more.

8. The atomizer according to claim 2, wherein the atomizing assembly comprises a liquid-absorbing member and a heating element, an outer side of the liquid-absorbing member is fitted to an inner side wall of the second liquid-conducting member facing away from the atomizer tube, a bottom end of the liquid-absorbing member is positioned higher than the liquid inlet holes, and the heating element is wrapped by the liquid-absorbing member.

9. The atomizer according to claim 8, wherein a distance between the bottom end of the liquid-absorbing member and a top edge of the liquid inlet holes in the axial direction of the atomizer tube is 0 to 28 mm.

10. The atomizer according to claim 9, wherein the distance between the bottom end of the liquid-absorbing member and the top edge of the liquid inlet holes in the axial direction of the atomizer tube is 5 to 20 mm.

11. The atomizer according to claim 1, wherein the atomizer further comprises a base, the liquid reservoir is disposed on the base and sealed at a bottom end by the base, and the atomizer tube is disposed in a space formed by the liquid reservoir and the base.

12. The atomizer according to claim 11, wherein a positioning sleeve is disposed on the base, the atomizer tube is sleeved on the positioning sleeve, and the liquid-conducting member is disposed between the atomizer tube and the positioning sleeve.

13. The atomizer according to claim 12, wherein the atomizing assembly further comprises a cotton-coated metal member, a bottom end of the cotton-coated metal member is embedded in a top of the positioning sleeve, and a top end of the cotton-coated metal member abuts against a bottom end of the atomizing assembly.

14. The atomizer according to claim 12, wherein an annular sealing groove is formed on the base and surrounds an outer side of the positioning sleeve, and a lower portion of the liquid reservoir is embedded in the annular sealing groove.

15. The atomizer according to claim 1, wherein the liquid inlet holes are disposed on a lower side wall of the atomizer tube.

16. An aerosol generating device comprising:
a housing; and
an atomizer mounted in the housing;
wherein the atomizer comprises:
an atomizer tube, one or more liquid inlet holes being disposed on a side wall of the atomizer tube;
a liquid reservoir disposed on an outer side of the atomizer tube and fluidly interconnected with the atomizer tube through the liquid inlet holes;
a liquid-conducting member fitted to an inner side wall of the atomizer tube and connected to the liquid inlet holes;
an atomizing assembly disposed in the atomizer tube and in contact with the liquid-conducting member, wherein the atomizing assembly is positioned higher than the liquid inlet holes in an axial direction of the atomizer tube.

17. The aerosol generating device according to claim 16, wherein the liquid-conducting member comprises a first liquid-conducting member and a second liquid-conducting member arranged sequentially from bottom to top along the axial direction of the atomizer tube, and the atomizing assembly is disposed in the second liquid-conducting member.

18. The aerosol generating device according to claim 17, wherein the atomizing assembly comprises a liquid-absorbing member and a heating element, an outer side of the liquid-absorbing member is fitted to an inner side wall of the second liquid-conducting member facing away from the atomizer tube, a bottom end of the liquid-absorbing member is positioned higher than the liquid inlet holes, and the heating element is wrapped by the liquid-absorbing member.

19. The aerosol generating device according to claim 18, wherein a distance between the bottom end of the liquid-absorbing member and a top edge of the liquid inlet holes in the axial direction of the atomizer tube is 0 to 28 mm.

20. The aerosol generating device according to claim 16, wherein the liquid inlet holes are disposed on a lower side wall of the atomizer tube.
